(19) United States
(12) Patent Application Publication
(10) Pub. No.: US 2006/0239447 A1
(43) Pub. Date: Oct. 26, 2006

(54) Earphone with selectable cable positioning

(75) Inventor: Gary Lester Sabick, Schaumburg, IL (US)

Correspondence Address: BANNER & WITCOFF, LTD., TEN SOUTH WACKER DRIVE, SUITE 3000, CHICAGO, IL, 60606, US

(73) Assignee: Shure Acquisition Holdings, Inc., Niles, IL (US)

(21) Appl. No.: 11/397,288

(22) Filed: Apr. 4, 2006

Related U.S. Application Data
(60) Provisional application No. 60/674,888, filed on Apr. 26, 2005.

(51) Int. Cl. H04M 1/00

(52) U.S. Cl. 379/430

(57) ABSTRACT

The invention provides apparatuses for an earphone in which a cable may be positioned by rotating a first earphone component about a second earphone component. The earphone has a nozzle that may mate with a sleeve and that fits into an ear of the user and a driver assembly. A body houses the driver assembly and is coupled to the nozzle. A swivel attaches to the body and may be rotated around the body by the user in order to position the cable. The swivel may include a first recess and a second recess that engage the pin. A pin fits into a selected recess of a swivel to provide a detent for each position of the cable, in which a spring that forces the pin into the selected recess. The swivel includes a ridge portion and the body includes a stop end, thus restricting the rotational movement of the swivel.

This application claims priority to provisional U.S. Application Ser. No. 60/674,888 (“Earphone with Selectable Cable Position”), filed Apr. 26, 2005.

### FIELD OF THE INVENTION

The invention relates to earphones, and more particularly earphones in which a cable may be positioned by rotating a first earphone portion about a second earphone portion.

### BACKGROUND OF THE INVENTION

Earphones may be worn in many ways. Typically, earphones are placed in the ear. An attached cable drops down past the bottom of the ear (“cable down”) and connects the earphones with the sound source. Alternatively, earphones may be placed in the ear, and the attached cable is placed over the ear (“cable over ear”), front to back, behind the ear. The cable then drops behind the ear and eventually connects to the sound system. In general, earphone designs are worn for a specific cable position.

Prior art earphone products manufactured by Shure Incorporated are designed so that the microphone cable is placed over the ear for overall best performance. However, the earphone may be worn in a “cable down” position with discomfort or degraded performance (resulting from an improper seal in the ear canal). Other models, such as the ER6 from Etymotic Research Inc., exit the wire straight out the earphone body, so the cable can drop down or be placed “over ear.” Exiting the cable straight out of the earphone makes the cable more visible and may also function as an undesirable moment arm. Consequently, the moment arm tends to pull out the earphone when wearing “cable down”.

Thus, there is a real need in the marketplace to provide an earphone in which the cable may be easily adjusted while maintaining the acoustical characteristics of the earphone and providing physical comfort to the user.

### BRIEF SUMMARY OF THE INVENTION

Aspects of the invention provide solutions to at least one of the issues mentioned above, thereby enabling one to construct an earphone in which a cable may be positioned by rotating a first earphone component about a second earphone component.

With one aspect of the invention, an earphone includes a nozzle that fits into an ear of the user and a driver assembly that converts an electrical signal into an acoustic signal and directs the acoustic signal into the nozzle. The nozzle may mate with a sleeve portion to provide an acoustic seal within the ear. The driver assembly is electrically coupled to the cable. A body houses the driver assembly and is coupled to the nozzle. A swivel attaches to the body and may be rotated around the body by the user in order to position the cable. A snap ring mechanically couples the swivel to the body. The swivel includes a first recess and a second recess that engage the pin approximately 120 degrees apart. The cable is electrically coupled to the driver assembly through the body. The cable is routed through an exit hole of the cover, a cable opening of the swivel, and a center opening of the swivel.

With another aspect of the invention, a pin that fits into a selected recess of a swivel to provide a detent for each position of the cable. A spring forces the pin into the selected recess.

With another aspect of the invention, an earphone has a swivel that includes a ridge portion and the body includes a stop end. The rotational movement of the swivel is restricted by the ridge portion contacting the stop end.

With another aspect of the invention, a cover fits over a swivel and mechanically couples to a body of the earphone. The cover and the swivel are able to rotate about the body.

With another aspect of the invention, an actuator fits into a selected hole of a swivel to provide a lock for each position of a cable. The actuator is released from the selected hole if the user depresses the actuator. A spring forces a protrusion of the actuator into the selected hole. The selected hole may be cylindrical in shape. The hole may be selected from one of two holes that are angularly separated by 120 degrees. A body of the earphone includes a recess that mates with the actuator. The spring fits into a hole formed in the body.

### BRIEF DESCRIPTION OF THE DRAWINGS

FIG. 1 shows positioning a cable position of an earphone according to an embodiment of the invention;

FIG. 2 shows a cable of an earphone that can rotate 120 degrees according to an embodiment of the invention;

FIG. 3 shows an external perspective view of an earphone with a selectable cable position according to an embodiment of the invention;

FIG. 4 shows an exploded view of the earphone shown in FIG. 3;

FIG. 5 shows an opposite exploded view of the earphone shown in FIG. 3;

FIG. 6 shows a perspective view of an earphone with a selectable cable position according to an embodiment of the invention;

FIG. 7 shows an exploded view of the earphone shown in FIG. 6; and

FIG. 8 shows an opposite exploded view of the earphone shown in FIG. 6.

### DETAILED DESCRIPTION OF THE INVENTION

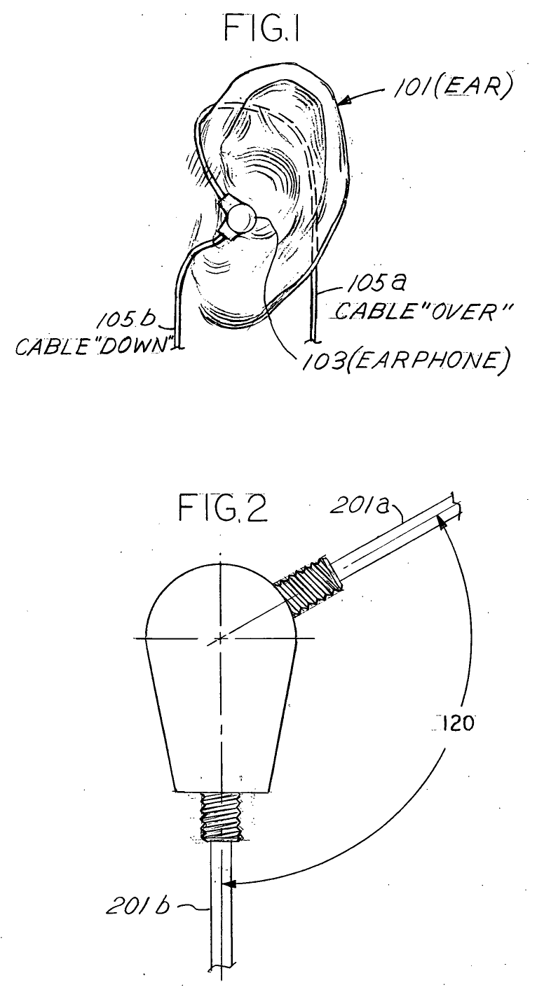

FIG. 1 shows positioning a cable position of earphone 103 according to an embodiment of the invention. Earphone 103 has a plurality of selectable cable positions when earphone 103 is placed into ear 101. In the embodiment, earphone 103 is removed from ear 101 when the user changes the cable position. However, other embodiments of the invention enable the user to change the cable position without extracting earphone 103 from ear 101. A cable (corresponding to 105a) may be placed over ear 101 or may be positioned down past the bottom of ear 101 (corresponding to 105b). (Cable 105a and 105b are physically the same cable associated with different positioning.) When the cable is placed over the ear, as shown in FIG. 1, the cable is placed front to back, although the embodiment also supports positioning the cable back to front of the ear. Cable 105a, 105b connects to a sound system (not shown). The user can select the cable positioning in accordance with the acoustic application.

FIG. 2 shows cable 201a, 201b of earphone 103 that can rotate 120 degrees according to an embodiment of the invention. With the embodiment, a user can rotate cable 201a, 201b for an approximately 120 degrees in order to position cable 201a, 201b either in the “cable down” position (corresponding to 201b) or in the “cable over ear” position (corresponding to cable 201a).

Earphone 103 may be configured so cable 201b exits down from the ear or may be configured so that cable 203a is wrapped over the ear. (Cable 201b and cable 201a are physically the same cable in different configured positions.) In either case, there is no required repositioning of the earphone nozzle within the ear. If cable 201a, 201b were not able to rotate, as shown in FIG. 2, the earphone cable may degrade the listening performance by adding noise from the cable rubbing and from pulling on the earphone to prevent a good seal in the ear. The “cable down” position may be desired while stationary, or sitting. The “cable over ear” typically isolates cable noise much better while being more securely held in the ear. The “cable over ear” position may be desired for musicians, singers, or other recreation activities.

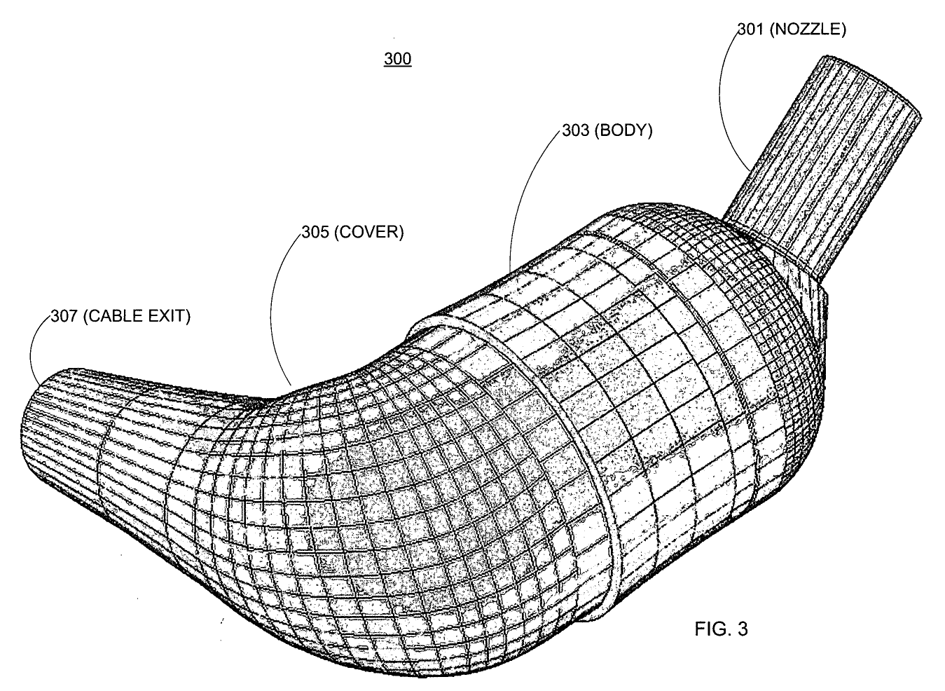

FIG. 3 shows external perspective view 300 of earphone 103 with a selectable cable position according to an embodiment of the invention. Earphone 103 includes nozzle 301, body 303, and cover 305. Nozzle 301 is angled (approximately 30 degrees) to fit into the user's ear canal. Body 303 connects nozzle 301 and cover 305. An earphone cable (not shown in the figure) exits through cable exit 307 and connects to an electrical source that corresponds to a sound to be recreated in the user's ear. In order to adjust the cable (not shown) the user rotates cover 305 into one of two positions. The first position corresponds to an “over ear” position (shown as cable 105a in FIG. 1). The second position corresponds to a “down” position (shown as cable 105b in FIG. 1). In the embodiment, the rotational separation between the first position and the second position is approximately 120 degrees, although the embodiment may support additional positions and may support different rotational separations.

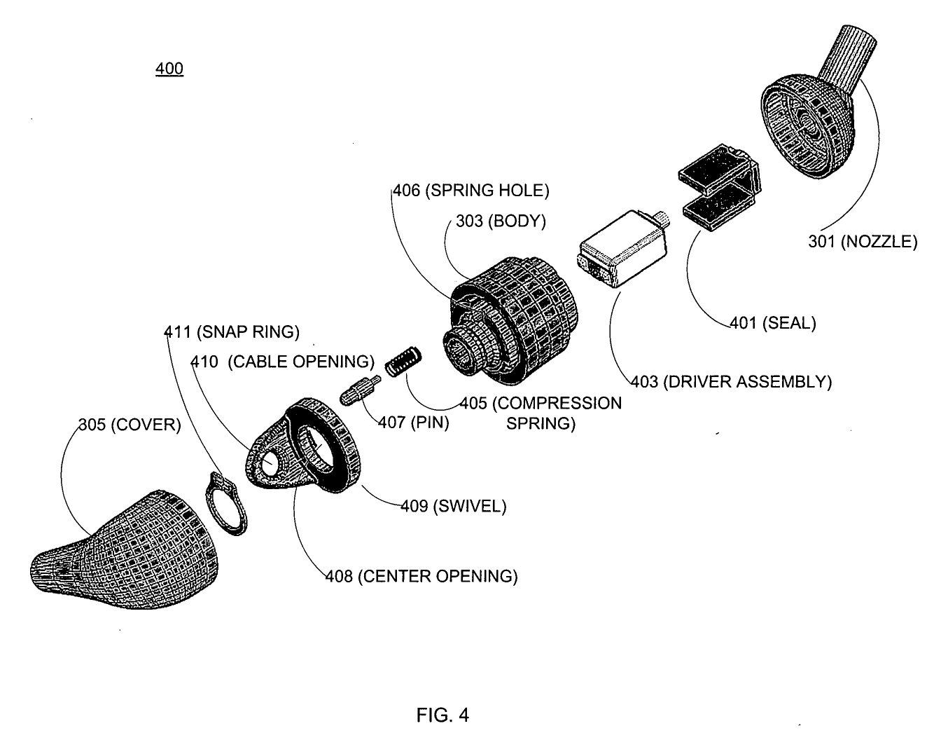

FIG. 4 shows exploded view 400 of earphone 103 shown in FIG. 3 in accordance with an embodiment of the invention. Driver assembly 403 is an internal speaker that produces sound, and is mounted inside plastic body 303. In the embodiment, body 303 is constructed from a thermo plastic, e.g., General Electric Cycoloy® C6200. Nozzle 301 mates with the body to channel sound into the ear. In the embodiment, nozzle 301 is constructed from a plastic, e.g., General Electric Cycoloy C6200. Sealing pad 401 between driver assembly 403 and nozzle 301 is included to prevent acoustic leaks. In the embodiment, sealing pad 401 is constructed from a foam rubber material, e.g., Poron® 4701-30-25035-04. An acoustic damper is mounted into nozzle 301. Nozzle 301 includes a sleeve portion (made of silicone or foam). In an embodiment of the invention, a sleeve portion mates with nozzle 301 to provide an acoustic seal with the ear canal. Because of the typical variations among ears, an embodiment utilizes a broad assortment of sleeves (e.g., Shure E Series Sleeves as described at www.shure.com/earphones/eseries_accessories.asp) to ensure a personalized fit, as well as to ensure proper sound isolation. A sleeve, which is often tubular in shape before being inserted into the ear canal, adapts to the shape of the ear canal when inserted.

A cable (not shown in FIG. 4), which is soldered to driver assembly 403, exits the rear of body 303 and is bonded with adhesive. Snap ring 411 secures swivel 409. In the embodiment, snap ring 411 is constructed from carbon spring steel, and swivel 409 is constructed from DuPont Delrin® 900P. In the embodiment, snap ring 411 fits into a groove formed in a cylindrical protrusion of body 303. Swivel 409 is allowed to rotate 120 degrees with relation to the body, and bends the cable 90 degrees to direct the cable away from body 303. The cable is routed through center opening 408 and cable opening 410. Both openings 408 and 410 are formed by swivel 409.

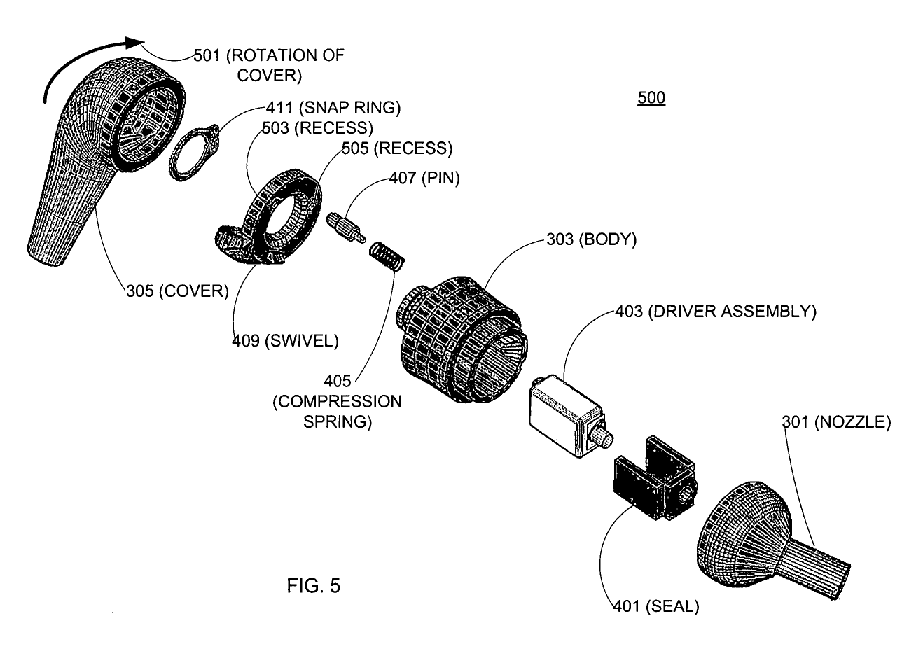

Spiral compression spring 405 fits into spring hole 406, which is formed by body 303. A protrusion of pin 407 fits within compression spring 405. In the embodiment, compression spring 405 is constructed from stainless spring steel, and pin 409 is constructed from a high strength plastic, e.g., DuPont Delrin 900P. When swivel 409 is moved to extreme angle positions, pin 407 is forced by compression spring 405 into a recess, providing a detent at each position. The recess is formed by swivel 409 and is not explicitly shown in FIG. 4 because the recess appears on a surface not exposed in FIG. 4. In the embodiment, two recesses are formed, each recess corresponding to the “cable down” position and the “cable over ear” position as shown in FIG. 2. In the embodiment, recesses 503 and 505 are shown in FIG. 5.

Cover 305 is stretched on to provide flex relief to the cable and rotates along with swivel 409. In the embodiment, cover 305 is constructed from a silicone rubber. Cover 305 hooks onto a ridge formed by body 303.

The user can rotate swivel 409. However, the rotation of swivel 409 is restricted by a ridge portion of swivel 409 contacting a step end that is formed by body 303. The rotational restriction prevents the user from continuously rotating cover 305. Without the rotational restriction, the cable would twist, possibly causing the cable to break.

FIG. 5 shows opposite exploded view 500 of earphone 103 shown in FIG. 3. FIG. 5 illustrates that the user is able to rotate cover 305 (corresponding to rotation movement 501). As previously discussed, the cable position may be rotated approximately 120 degrees in order to configure one of two positions. However, other embodiments of the invention support more than two selectable positions. Also, other embodiments of the invention support selectable positions that have a rotational separation different from 120 degrees.

In the embodiment shown in FIG. 5, pin 407 is forced into one of recesses 503 and 505, corresponding to the “cable down” position and the “cable over ear” position as shown in FIG. 2.

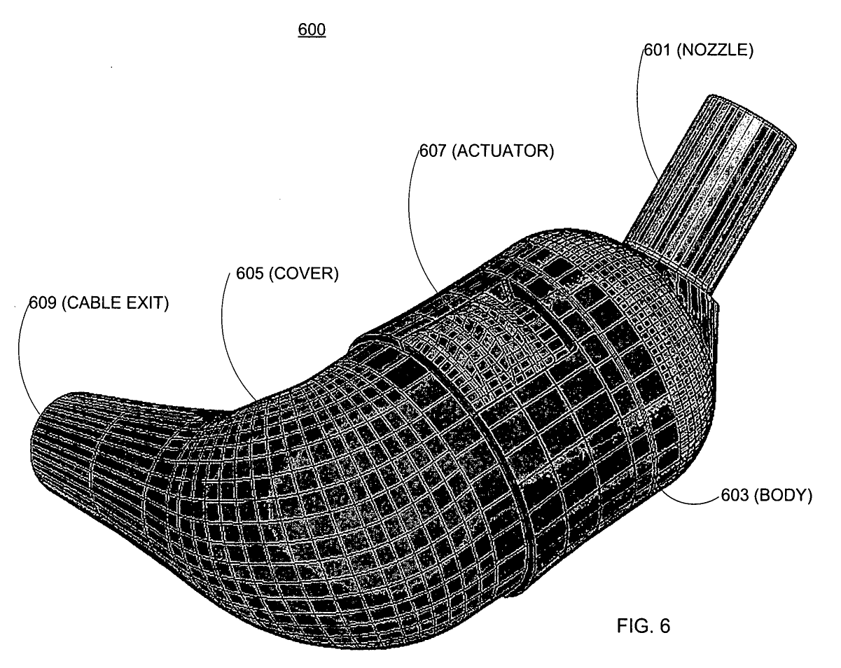

FIG. 6 shows perspective view 600 of earphone 103 with a selectable cable position according to an embodiment of the invention. As with the embodiment shown in FIG. 3, earphone 103 includes nozzle 601 (corresponding to nozzle 301), body 603 (corresponding to body 303), and cover 605 (corresponding to cover 305). The cable exits cable exit 609. Also, the embodiment shown in FIG. 6 includes actuator 607. When actuator 607 is depressed, the user can rotate cover 605 in order to select one two positions as previously discussed. In the embodiment, actuator 607 is constructed from a plastic, e.g., DuPont Delrin 900P.

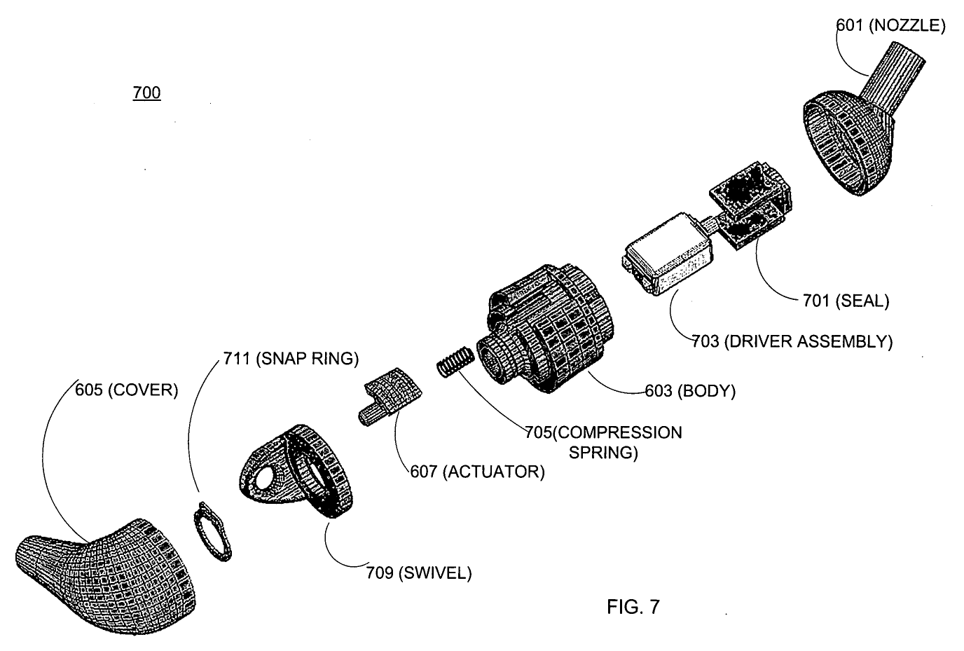

FIG. 7 shows exploded view 700 of earphone 103 shown in FIG. 6. Driver assembly 703 is an internal speaker that produces sound, and is mounted inside plastic body 603. Nozzle 601 mates with the body to channel sound into the ear. Sealing pad 701 between driver assembly 703 and nozzle 601 is included to prevent acoustic leaks. An acoustic damper is mounted into nozzle 601. Nozzle 601 includes a sleeve portion (made of silicone or foam). The sleeve portion provides a seal with the ear canal.

A cable (not shown in FIG. 7), which is soldered to driver assembly 703, exits the rear of body 603 and is bonded with adhesive. Snap ring 711 secures swivel 709. In the embodiment, snap ring 711 fits into a groove formed in a cylindrical protrusion of body 603. Swivel 709 is allowed to rotate 120 degrees with relation to the body, and bends the cable 90 degrees to direct the cable away from body 603.

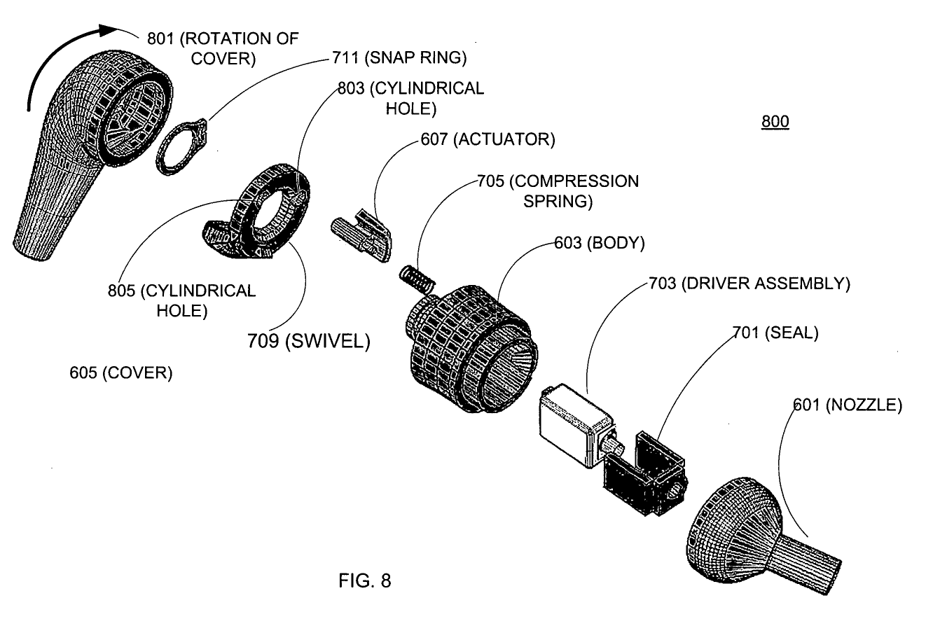

Actuator 607 and compression spring 705 fit into a mating recess portion of body 603. A protrusion of actuator 607 fits within compression spring 705, which is shown in FIG. 8. When swivel 709 is moved to extreme angle positions, actuator 607 is forced by compression spring 705 into a cylindrical hole, providing a lock at each position. The cylindrical hole is formed by swivel 709 and is not explicitly shown in FIG. 7 because the cylindrical hole appears on a surface not exposed in FIG. 7. In the embodiment, two cylindrical holes are formed with each cylindrical hole corresponding to the “cable down” position and the “cable over ear” position as shown in FIG. 2. In the embodiment, cylindrical holes 803 and 805 are shown in FIG. 8.

Cover 605 is stretched on to provide flex relief to the cable and rotates along with swivel 709. In the embodiment, cover 605 is constructed from a silicone rubber. Cover 605 hooks onto a ridge formed by body 603.

The user can rotate swivel 709. However, the rotation of swivel 709 is restricted by a ridge portion of swivel 709 contacting a step end that is formed by body 603. The rotational restriction prevents the user from continuously rotating cover 605. Without the rotational restriction, the cable would twist, possibly causing the cable to break.

FIG. 8 shows opposite exploded view 800 of earphone 103 shown in FIG. 6. FIG. 8 illustrates that the user is able to rotate cover 605 (corresponding to rotation 801). As previously discussed, the cable position may be rotated approximately 120 degrees in order to configure one of two positions. However, other embodiments of the invention support more than two selectable positions. Also, other embodiments of the invention support selectable positions that have a rotational separation different from 120 degrees.

In the embodiment shown in FIG. 8, actuator 607 is forced into one of cylindrical holes 803 and 805, corresponding to the “cable down” position and the “cable over ear” position as shown in FIG. 2.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. An earphone that enables a user to position a cable, comprising:
a nozzle fitting into an ear of the user;
a driver assembly converting an electrical signal into an acoustic signal and directing the acoustic signal into the nozzle, the driver assembly being electrically coupled to the cable;
a body housing the driver assembly, the body being coupled to the nozzle; and
a swivel attaching to the body, the swivel being able to be rotated around the body by the user in order to position the cable.

2. The earphone of claim 1, further comprising:
a pin fitting into a selected recess of the swivel to provide a detent for each position of the cable.

3. The earphone of claim 2, further comprising:
a spring forcing the pin into the selected recess.

4. The earphone of claim 1, the swivel including a ridge portion and the body including a stop end, rotational movement of the swivel being restricted by the ridge portion contacting the stop end.

5. The earphone of claim 1, further comprising:
a snap ring mechanically coupling the swivel to the body.

6. The earphone of claim 1, further comprising:
a cover fitting over the swivel, the cover being mechanically coupled to the body, the cover and the swivel being able to rotate about the body.

7. The earphone of claim 2, the swivel including a first recess and a second recess that engage the pin approximately 120 degrees apart.

8. The earphone of claim 1, further comprising:
an actuator fitting into a selected hole of the swivel to provide a lock for each position of the cable, the actuator being released from the selected hole if the user depresses the actuator.

9. The earphone of claim 2, further comprising:
a spring forcing a protrusion of the actuator into the selected hole.

10. The earphone of claim 9, the selected hole being cylindrical in shape.

11. The earphone of claim 8, the swivel including a first hole and a second hole that engage the actuator approximately 120 degrees apart.

12. The earphone of claim 8, the body including a mating recess portion that mates with the actuator.

13. The earphone of claim 9, the spring fitting into a hole formed in the body.

14. The earphone of claim 1, the cable being electrically coupled to the driver assembly through the body.

15. The earphone of claim 14, the cable being routed through an exit hole of the cover, a cable opening of the swivel, and a center opening of the swivel.

16. The earphone of claim 1, further comprising:
a sleeve portion mating with the nozzle to provide an acoustic seal within the ear.

17. The earphone of claim 1, further comprising:
an acoustic damper mounted into the nozzle.

18. The earphone of claim 8, the actuator being forced into one of two holes, the first hole corresponding to a cable down position and the second hole corresponding to a cable over the ear position.

19. An earphone that enables a user to position a cable, comprising:
a nozzle fitting into an ear of the user;
a driver assembly converting an electrical signal into an acoustic signal and directing the acoustic signal into the nozzle, the driver assembly being electrically coupled to the cable;
a body housing the driver assembly, the body being coupled to the nozzle;
a swivel attaching to the body, the swivel being able to rotate around the body by the user in order to position the cable and being mechanically coupled to the body;
a cover fitting over the swivel, the cover fitting being mechanically coupled to the body, the cover and the swivel being able to rotate about the body; and
an actuator fitting into a selected hole of the swivel to provide a lock for each position of the cable, the actuator being released from the selected hole if the user depresses the actuator.

20. An earphone that enables a user to position a cable, comprising:
a nozzle fitting into an ear of the user;
a sleeve portion mating with the nozzle to provide an acoustic seal within the ear;
a driver assembly converting an electrical signal into an acoustic signal and directing the acoustic signal into the nozzle, the driver assembly being electrically coupled to the cable;
a body housing the driver assembly, the body being coupled to the nozzle;
a swivel attaching to the body, the swivel being able to rotate around the body by the user in order to position the cable and being mechanically coupled to the body;
a pin fitting into a selected recess of the swivel to provide a detent for each position of the cable;
a cover fitting over the swivel, the cover fitting being mechanically coupled to the body, the cover and the swivel being able to rotate about the body; and
an actuator fitting into a selected hole of the swivel to provide a lock for each position of the cable, the actuator being released from the selected hole if the user depresses the actuator, the actuator being forced into one of two holes, the first hole corresponding to a cable down position and the second hole corresponding to a cable over the ear position.
